(19) United States
(12) Patent Application Publication
(10) Pub. No.: US 2015/0244407 A1
(43) Pub. Date: Aug. 27, 2015

(54) Mobile Device Compact Case

(71) Applicant: Enrique Peral, San Juan, PR (US)

(72) Inventor: Enrique Peral, San Juan, PR (US)

(21) Appl. No.: 14/189,514

(22) Filed: Feb. 25, 2014

(51) Int. Cl. H04B 1/3888

(52) U.S. Cl. CPC H04B 1/3888

(57) ABSTRACT

The present disclosure relates to a mobile device protective case comprises a housing, a tray and a cover. The present disclosure includes a protective case including a chamber, wherein said chamber comprises a storage area limited to a particular area of the back part of the mobile device protective case avoiding damages to several features of the mobile device.

### STATEMENT REGARDING FEDERALLY SPONSORED RESEARCH AND DEVELOPMENT

N/A

### RELATED APPLICATIONS

N/A

### BACKGROUND OF THE DISCLOSURE

1. Field of the Disclosure

The present disclosure relates to improvements in a mobile device carrying case. More particularly, a mobile device case carrying a compact case allowing the mobile device to be utilized while the mobile device case allows to storage or remove some personal items.

2. Discussion of the Background

A growing majority of people carry a mobile device on a regular basis. Some people add or buy protective cover or cases in order to offer a protective pouch for the mobile device and, in some cases, a small space is created between the mobile device. The space is used for storing money, cards or the like. These protective cases require the user to remove the mobile device from the case to access the phone and/or the money, cards or the like. They further provide limited space for storage of personal items and the personal items shifts as the user is carrying the case.

A number of patents have been issued that provide for holding mobile devices covers. Exemplary examples of patents that have been issued that try to address this problem.

U.S. Pat. No. 7,146,184 issued Dec. 5, 2006 to Tsitsiashvili, discloses a personal communication and cosmetic storage device comprising a housing including personal communication circuitry having a first input portion and a second output portion pivotally connected to one another. At least one cosmetic storage layer is positioned within the first input layer for retaining and storing at least one type of cosmetic therein. The device further includes a means for accessing the at least one cosmetic storage layer. The device is selectively operable in a first mode as a personal communication device and, in a second mode upon accessing the at least one cosmetic storage layer thereby allowing a user to access the stored cosmetic for application thereof. The compartment for the cosmetic storage does not allow for use of the phone while it is using the cosmetic application. This patent also do not include space for storing other personal items.

U.S. Pat. No. 7,340,238 issued Mar. 4, 2008 to Napier-Clark, discloses a portable personal communications and cosmetics apparatus comprising a base unit having side walls with cavities therein for receiving removable cosmetics products and a mobile phone unit mounted, e.g. removable, on the base unit. The compartment for the cosmetic storage does not provide enough space for personal item or the capacity for changing the cavities dimensions for storing personal items.

U.S. Publication 2011/0077061 published on Mar. 31, 2011 to Danze et al. discloses the retention of a cell phone to allow for complete functionality of the phone while it is within the case. The phone is cushioned and protected within the case where it is semi-rigidly held. The case further includes an operable back cover where interchangeable trays can be installed where the trays provide a variety of function such as holding makeup, pills, money, credit cards, key(s) or other items a user might normally carry. A dust flap protects migration of makeup into the phone area. The door(s) can open from a variety of methods including hinged, sliding or rotating and be retained closed with magnets or snaps. The opening of the door may also activate an integrated light or alarm. However, the compartment for storage personal items extends over some mobile's features, such as the camera, that could be damaged by the elements stored at the trays. For example, in case a candy stored at the trays melts it can end up over the camera without the user noticing it. Therefore, it is important to provide chambers separated from some mobile features in order to avoid damages to the structures.

Therefore, there is a need for providing a mobile device case that allows for full functioning of a mobile device while the mobile device is installed within the case and avoid damages to several mobile device features. Further, the mobile device case includes interchangeable trays for money, credit cards, makeup and the like.

### SUMMARY

The present disclosure relates to a protective case comprises a housing, a tray and a cover. The present disclosure includes a protective case including a chamber, wherein said chamber comprises a cavity or storage area limited to a particular area of the back part of the mobile device protective case avoiding damages to several features of the mobile device.

In accordance with the principles of the present disclosure the case includes a housing comprising a front-face housing, a back-face housing and a top back-face housing. The back-face housing comprises a recess or chamber limited by side walls and bottom back-face housing. The back-face housing could be integrately made with the the bottom back-face housing and the side walls, wherein said back-face housing is configured to create a flange between the top back-face housing and the top back-face housing. The top back-face housing extends away from the chamber and comprises at least a cavity in order to provide access for several mobile device features, such as, a camera, a microphone and any feature that requires access to the mobile device.

In general, the present disclosure overcomes the disadvantages and shortcomings of prior art by disclosing a top back-face housing protecting several features of the mobile device from damages produced by personal items stored at the chamber.

Another object of this disclosure is to provide enough space to store several personal items, including but not limit to pill, keys, tampons, candy and other personal items.

Another object of this disclosure is to provide a changeable tray for providing different sizes and material, wherein the size and material use for the trays limits the movement of the personal item.

The disclosure itself, both as to its configuration and its mode of operation will be best understood, and additional objects and advantages thereof will become apparent, by the following detailed description of a preferred embodiment taken in conjunction with the accompanying drawings.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the disclosure of the application, which is measured by the claims, nor is it intended to be limiting as to the scope of the disclosure in any way.

### BRIEF DESCRIPTION OF THE DRAWINGS

The accompanying drawings, which are incorporated herein, constitute part of the specification and illustrate the preferred embodiment of the disclosure.

FIG. 1A-1B shows a general structure of the compact case in accordance with the principles of the present disclosure.

FIG. 2 shows a general structure of the housing in accordance with the principles of the present disclosure.

FIG. 3 shows a general structure of the tray in accordance with the principles of the present disclosure.

FIG. 4A through FIG. 4C shows trays exemplary embodiments in accordance with the principles of the present disclosure.

FIGS. 5A through 5B shows a cover for the housing in accordance with the principles of the present disclosure.

FIG. 6 shows a first exemplary embodiment of the cover-housing assembling in accordance with the principles of the present disclosure.

FIG. 7 shows a first exemplary embodiment of the compact case assembling in accordance with the principles of the present disclosure.

FIG. 8 shows a sectioned view of the in accordance with the principles of the present disclosure.

FIG. 9 shows an isometric view of the housing in accordance with the principles of the present disclosure.

FIG. 10 shows a top back face of the housing in accordance with the principles of the present disclosure.

FIG. 11 shows a first exemplary embodiment of the compact case-mobile device assembling in accordance with the principles of the present disclosure.

### DESCRIPTION OF THE PREFERRED EMBODIMENT

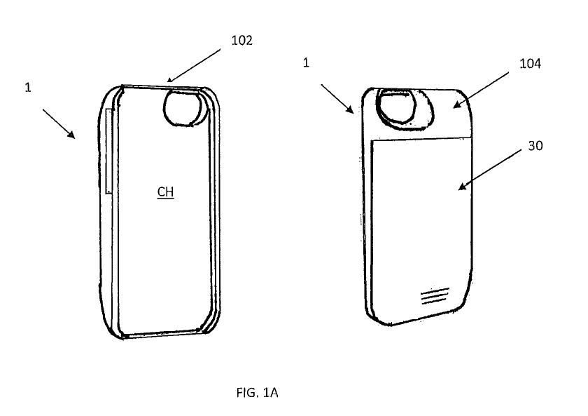

FIG. 1A and FIG. 1B show a general structure of compact case 1 in accordance with the principles of the present disclosure. The compact case 1 mainly comprises a housing base 10, a tray 20 and a cover 30. The housing base 10 comprises front-face housing 102 having a planar surface and external walls extending vertical from said planar surface creating a front-face chamber CH to provide access to a display screen of a mobile device; and a back part comprising at least a back-face housing BF and top back-face housing 104.

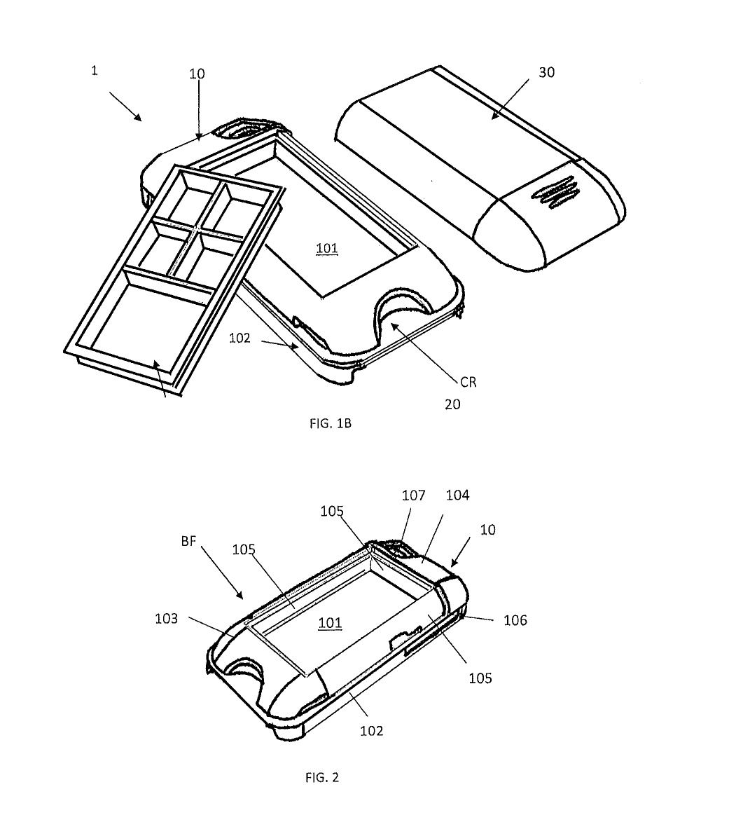

FIG. 2 is directed to the housing base 10, wherein said housing base 10 comprises a front-face housing 102, a back-face housing comprising a bottom back-face housing 103 and at least two side walls 105. The bottom back-face housing 103, the top back-face housing 104 and side walls 105 creates a cavity, recess or chamber 101. The back-face housing 103 could be made integrally with the bottom back-face housing 104 and the side walls 105. The side walls 105 are configured to create a flange 106 between the top back-face housing 104 and the back-face housing 103. The top back-face housing 104, covers several mobile's features and limits the chamber area, wherein said top back-face housing 104 comprises at least a cavity 107 in order to provide access said several mobile device features, such as, a camera, a microphone and any feature that requires access to the mobile device. Further a slot CR for inserting credit card is created between the back part of the front-face housing 102 and said bottom back-face housing 103 as shown in FIG. 1B.

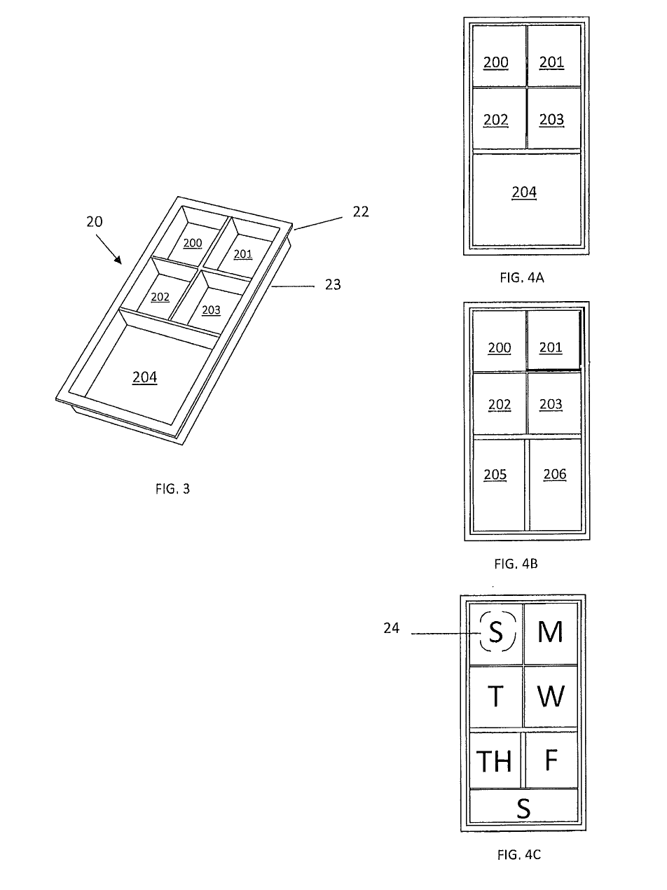

FIG. 3 is directed to the changeable tray 20 comprising tray cavities 200-206. The tray cavities 200-206 may have different shapes or configurations, as shown in FIG. 4A though FIG. 4C. Further said cavities 200-206 comprise some indicia in order to identify each cavity for several purposes, such as, a time, name, texture or color. Having different indicia assist to identify or correlates the material or personal item inside the cavities. For example, as shown in FIG. 4C, cavities my include letters to identify weeks days which at the same time can be correlated to the day-pills located inside each identified cavity. Several material can be used for the trays, however materials with a robust resilient material. The robust salient material withstands or absorbs the vibration and/or shacking action of components such as pill inside the cavities 200-206. Having a resilient material inside the cavities or surrounding the components inside cavities 200-206 reduces the sounds produced by the contacting action between the tray's wall and items.

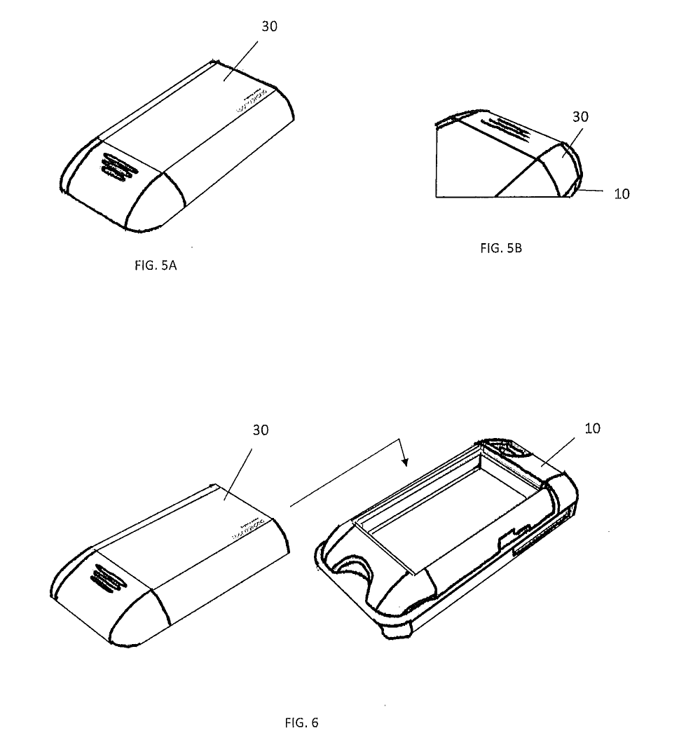

A cover 30, as shown in FIG. 5A and FIG. 5B, is positioned on top of the bottom back-face housing 103 and side walls 105 in order to cover the tray 20 located at the chamber 101, as shown in FIG. 6. Cover 30 is configured to be fixed on top of the back-face 103 and side walls 105 of the housing base 10. Several means can be used to fix the cover on top on the back-face 103, such as snap-on features in order to avoid the unwanted movement of cover 30.

Further the flange's 106 contour assists to limit the cover's 30 movement toward the top back-face 104 of the housing base 10.

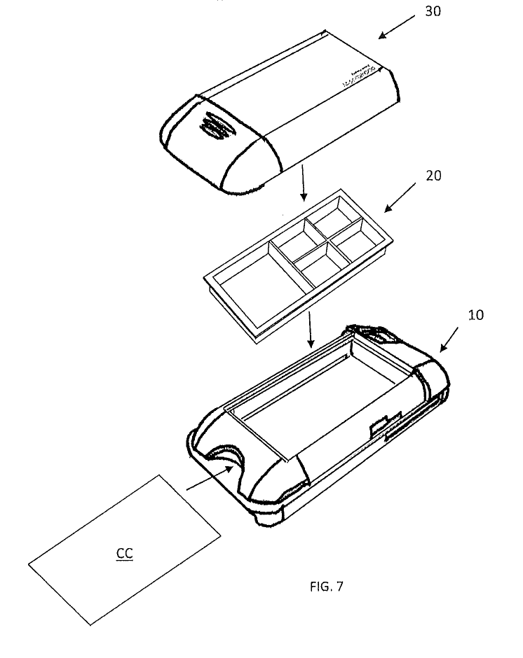

FIG. 7 discloses the assembling of the cover 30, tray and housing base 10. A credit card CC is inserted through slot CR, as explained above. The slot CR extends inside side walls 105 in order to provide enough space for the credit cards. Important to understand that the slot CR is wide enough to provide space for at least a credit card, wherein said credit card CC is located inside the slot CR and simultaneously remains under the tray 20.

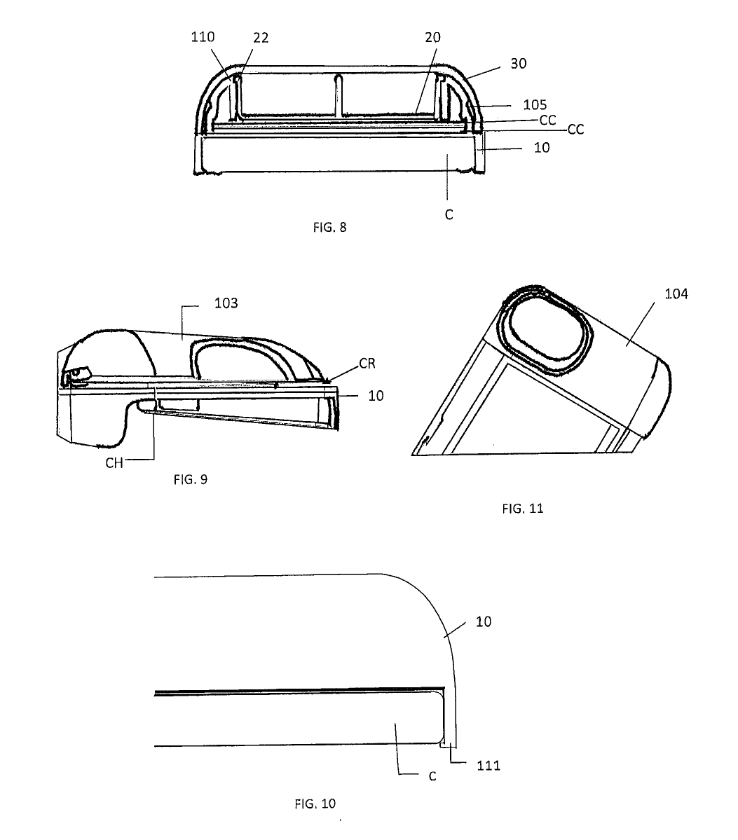

FIG. 8 shows a sectional view of how the cover 30 is positioned on top of the tray 20 and bottom back-face 103 of housing base 10. As shown, is clearly disclosed that the chamber 101 at the back-face BF is configured to receive tray 20, wherein tray flanges 22 extends from the tray to sit at a recess 110 at bottom back-face 103 and side walls 105. Further more than one credit card CC is positioned below the tray 20.

Further the mobile device C is positioned at the front-face 102 of housing base 10 in the front-face chamber CH, as shown in FIG. 9. Clearly show front-face side wall 102 covering and holding said mobile device C. In order to attached and fix the mobile device C inside the front-face chamber CH protrusions 111 are extended from front-face side walls 102 as shown in FIG. 10.

The disclosure is not limited to the precise configuration described above. While the disclosure has been described as having a preferred design, it is understood that many changes, modifications, variations and other uses and applications of the subject disclosure will, however, become apparent to those skilled in the art without materially departing from the novel teachings and advantages of this disclosure after considering this specification together with the accompanying drawings. Accordingly, all such changes, modifications, variations and other uses and applications which do not depart from the spirit and scope of the disclosure are deemed to be covered by this disclosure as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present disclosure, as well as equivalents thereof. The details in the patents, patent applications, and publications incorporated by reference herein may be considered to be incorporable at applicant's option during prosecution as further limitations to patently distinguish the present disclosure from any applied prior art.

1. A mobile device protective case comprising:
a cover;
at least a changeable tray; and
a housing base comprising a front-face housing having an planar surface and external walls extending vertical from said planar surface creating a front-face chamber to provide access to a display screen of a mobile device; a back face housing comprising a bottom back-face housing and at least two side walls; a top back-face housing, wherein said bottom back-face housing, the top back-face housing and the at least two side walls creates a chamber;
wherein said chamber includes a spacing to accept said changeable tray;
wherein said top back-face housing is configured to at least one mobile device feature away from the chamber; and
wherein said cover is configured to be positioned on said bottom back-face housing and said side walls.

2. The mobile device protective case according to claim 1,
wherein a slot between the back part of the front-face housing and said bottom back-face housing providing access to said chamber.

3. The mobile device protective case according to claim 1,
wherein the changeable tray comprises several cavities.

4. The mobile device protective case according to claim 1,
wherein the changeable tray comprises a robust resilient material

5. The mobile device protective case according to claim 1,
wherein said cover covers the chamber and extends away from the top back-face housing.

6. The mobile device protective case according to claim 1,
wherein said front-face housing, said back-face housing is made from plastic.

7. The mobile device protective case according to claim 1,
wherein said front-face housing has opening for access to electrical connections to said mobile device.

8. The mobile device protective case according to claim 1,
wherein said external walls extending vertical from said planar surface comprises at least a protrusion, wherein said protrusion is parallel to said planar surface.

9. The mobile device protective case according to claim 1,
wherein said cover is configured to be fixed on top of the back-face housing and said at least two side walls by a fixing mechanism.
